(19) United States
(12) Patent Application Publication
(10) Pub. No.: US 2018/0104808 A1
(43) Pub. Date: Apr. 19, 2018

(54) SKATEBOARD TOOL WITH ENHANCED STORAGE CAPACITY

(71) Applicant: Adam Trent Goeglein, Agoura Hills, CA (US)

(72) Inventor: Adam Trent Goeglein, Agoura Hills, CA (US)

(21) Appl. No.: 15/784,978

(22) Filed: Oct. 16, 2017

Related U.S. Application Data
(60) Provisional application No. 62/410,236, filed on Oct. 19, 2016.

(51) Int. Cl. B25F 1/02; B25B 13/46; B25B 15/00; B26B 11/00; B25G 1/10; B25G 1/08; B23G 5/20; A63C 17/00

(52) U.S. Cl. CPC B25F 1/02; B25B 13/46; B25B 15/005; B25B 15/008; A63C 17/0006; B25G 1/102; B25G 1/085; B23G 5/20; B26B 11/00

(57) ABSTRACT

A skateboard tool with enhanced portability and storage capacity to store a plurality of tools is provided. The skateboard tool includes a main body member having an upper portion, a lower portion and a side wall connecting the upper and lower portions together, the upper portion having an upper opening that extends to an internal cavity formed by the side wall and the lower portion, a lid detachably coupled to the upper portion of the main body member to enclose the internal cavity, and a driver coupled to the lower portion of the main body member. The plurality of tools is disposed within the internal cavity of the main body member and includes at least one socket designed to couple to the driver. The socket is designed to communicate with the skateboard to permit the user to perform a maintenance on the skateboard.

### RELATED APPLICATION

The application claims priority to provisional patent application U.S. Ser. No. 62/410,236 filed on Oct. 19, 2016, the entire contents of which is herein incorporated by reference.

### BACKGROUND

The embodiments herein relate generally to tools for performing skateboard repairs and/or maintenance. More specifically, embodiments of the invention are directed to a skateboard tool configured to store a plurality of tools necessary to service a skateboard.

Skateboarding is a fast-moving, dangerous and high-impact activity that requires the rider to perform a variety of jumps and/or athletic moves with a skateboard. The skateboard serves as the vehicle that travels on the ground, supports the rider's weight and absorbs impact during jumps. Under these circumstances, the skateboard is subject to great stresses, wear and/or damage. As a result, the components of the skateboard including the deck, trucks, wheels and axles require service including the replacement and/or readjustment of the components and any mechanical fasteners associated with the components.

Many useful tools for servicing skateboards exist separately such as screw drivers, socket wrenches, and the like. However, it is difficult for the user to carry all of these items together and store them at one convenient location. U.S. Pat. No. 6,279,434 discloses a skateboard specific tool comprising a T-shaped member designed to secure three sockets and a cavity to secure an Allen Key. However, this skateboard tool is limited because the T-shape is bulky and oddly shaped, which makes it difficult and/or uncomfortable for the user to store in a clothing pocket. In addition, this skateboard tool is undesirable because it does not provide and is not configured to store other tools that are helpful in performing service on a skateboard including, but not limited to, a ratchet mechanism, bit driver, axle rethreader, griptape file, bearing press and razor blade.

As such, there is a need in the industry for a skateboard tool with enhanced storage capacity that addresses the limitations of the prior art, which is configured to conveniently store a plurality of tools including, but not limited to, sockets, bit driver, griptape file, bearing press, razor blade and L-tool.

### SUMMARY

A skateboard tool with enhanced portability and storage capacity to store a plurality of tools is provided. The plurality of tools are configured for use by a user to service a skateboard. The skateboard tool comprises a main body member comprising an upper portion, a lower portion opposite the upper portion, and a side wall connecting the upper and lower portions together, the upper portion comprising an upper opening that extends to an internal cavity formed by the side wall and the lower portion, the internal cavity configured to store the plurality of tools therein, a lid detachably coupled to the upper portion of the main body member to enclose the internal cavity, and a driver coupled to the lower portion of the main body member, wherein the plurality of tools is disposed within the internal cavity of the main body member and comprises at least one socket configured to couple to the driver, the socket configured to communicate with the skateboard to permit the user to perform a maintenance on the skateboard.

In certain embodiments, the plurality of tools are selected from the group consisting of a first socket, a second socket, a third socket, an axle rethreader, a bit driver, a griptape file, a bearing press, a razor blade, and a L-tool comprising an Allen wrench on a first side and a Philips screw driver head on a second side.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a top perspective view of certain embodiments of the skateboard tool;

FIG. 2 depicts a bottom perspective view of certain embodiments of the skateboard tool;

FIG. 3 depicts a top perspective view of certain embodiments of the skateboard tool illustrating the lid in an adjusted configuration;

FIG. 4 depicts an exploded view of certain embodiments of the skateboard tool;

FIG. 5 depicts a bottom perspective view of certain embodiments of the skateboard tool illustrating the lid;

FIG. 6 depicts a top perspective view of certain embodiments of the skateboard tool; and

FIG. 7 depicts a section view of certain embodiments of the skateboard tool taken along line 7-7 in FIG.1.

### DETAILED DESCRIPTION OF CERTAIN EMBODIMENTS

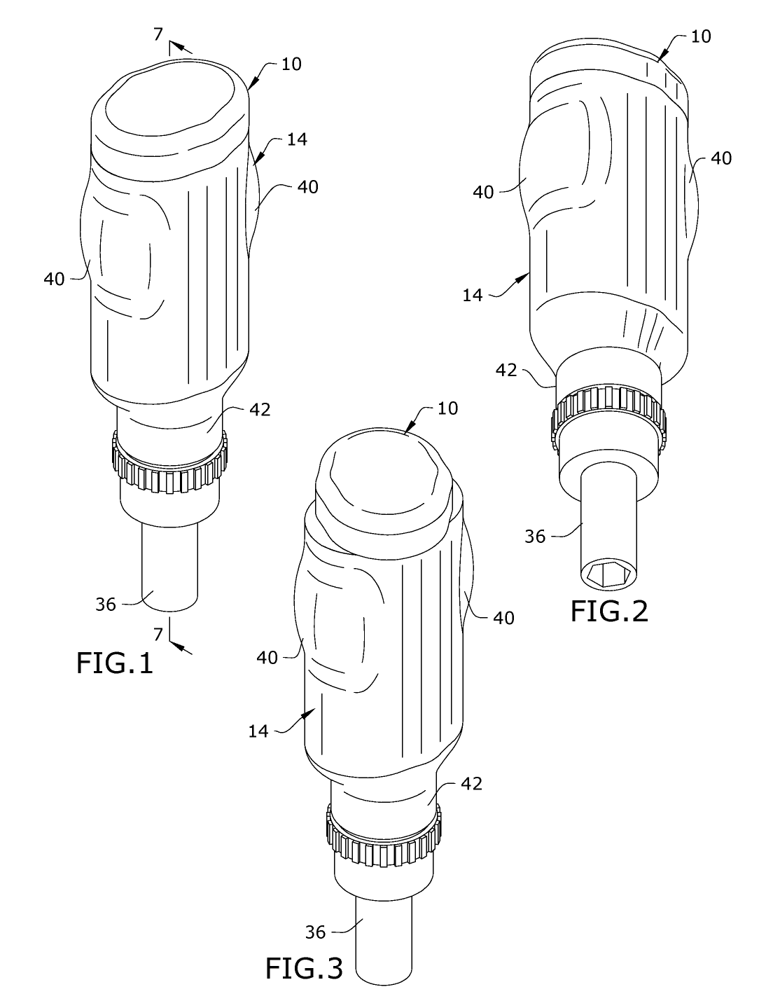

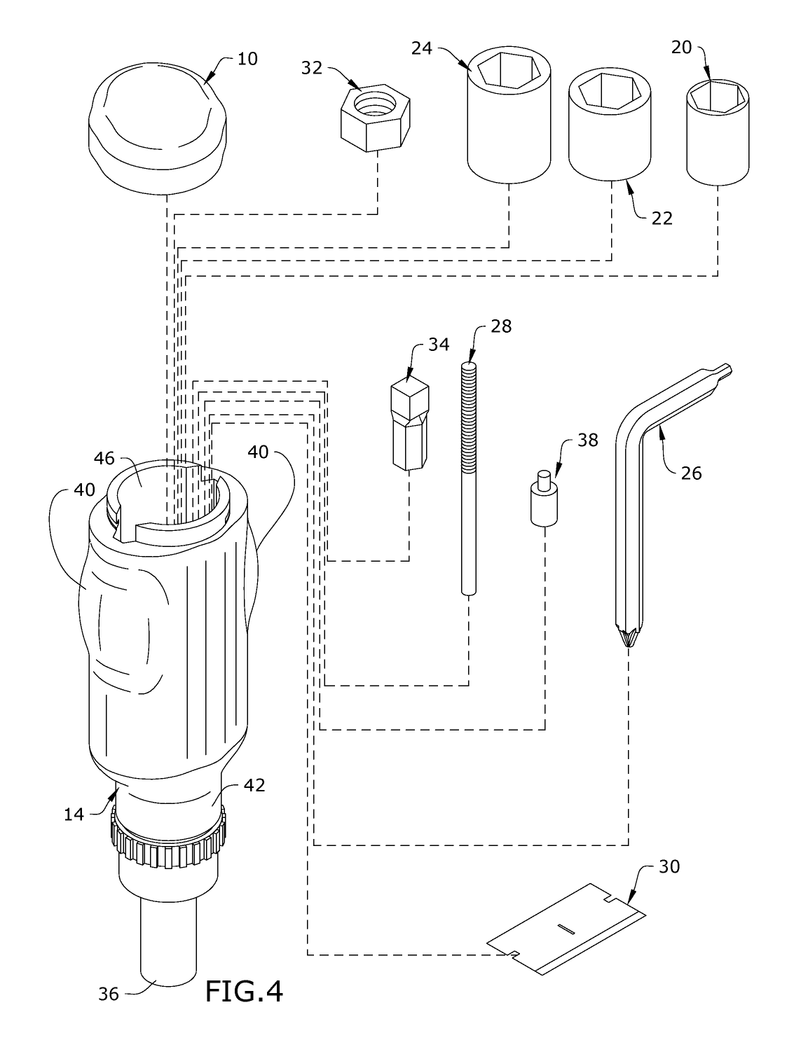

As depicted in FIGS. 1-4, the skateboard tool is configured for use to service a skateboard (not shown). More specifically, the skateboard tool permits a user to replace and/or readjust components of the skateboard including the deck, trucks, wheels, axles, and any relevant mechanical fasteners used with the skateboard components. In certain embodiments, the skateboard tool generally comprises lid 10, body 14, lower neck 42 and driver 36. The skateboard tool is preferably made from a plastic or rubber material. However, alternative materials known in the field may be used instead.

Body 14 comprises an upper opening connected to internal cavity 46, which is sufficiently large to store a plurality of tools including ⅜″ socket 20, ½″ socket 22, 9/16″ socket 24, L-tool 26, griptape file 28, razor blade 30, axle rethreader 32, bit driver 34 and bearing press 38. The bottom of body 14 is connected to lower neck 42, which is coupled to driver 36. The exterior surface of body 14 comprises a pair of grip protrusions 40 which are oppositely oriented from each other. Grip protrusions 40 conform to contours of the user's hand to enhance grip when the skateboard tool is in use.

In one embodiment, the skateboard tool is approximately 6½″-7″ long, 2″ wide at body 14 and 1″ wide at lower neck 42. However, it shall be appreciated that the dimensions of the skateboard tool may vary. In one embodiment, ratchet mechanism 18 is disposed within lower neck 42 and operably connected to driver 36.

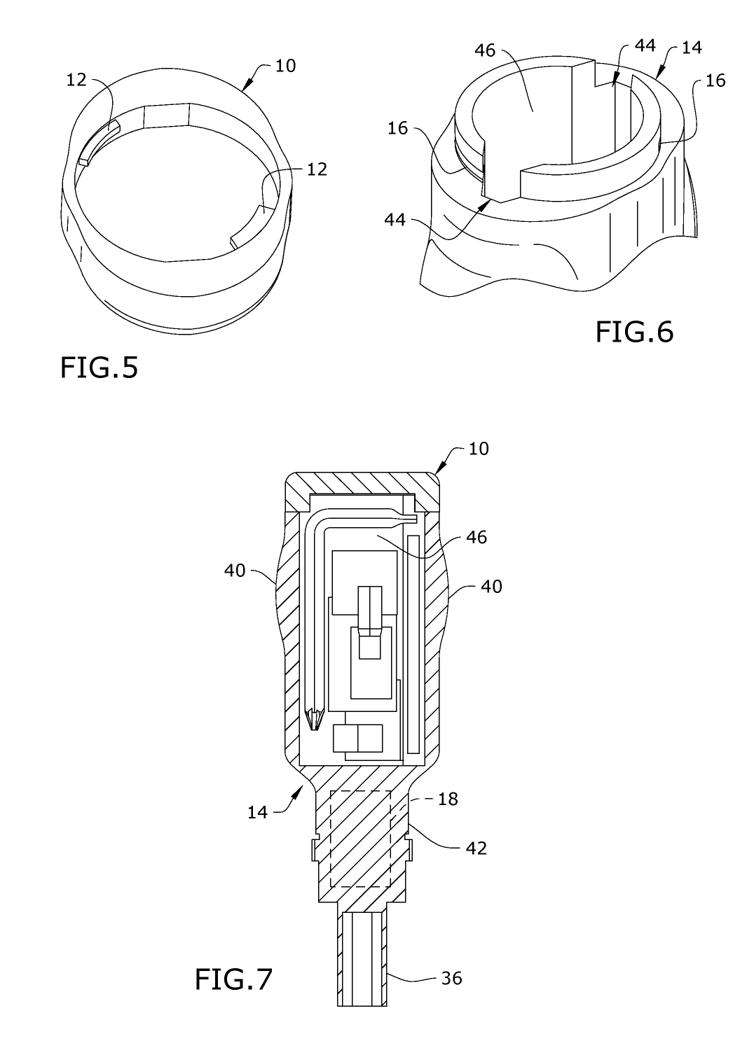

Lid 10 is detachably coupled to the top of body 14 to enclose internal cavity 46. Lid 10 comprises a pair of internal locking protrusions 12 as depicted in FIG. 5. As depicted in FIG. 6, the top of body 14 comprises a pair of slots 16 and cutouts 44. Internal locking protrusions 12 are configured to communicate with slots 16 of body 14 to adjust lid 10 to either a locked position or unlocked position. More specifically, lid 10 is twisted to slide internal locking protrusions 12 within slots 16 of body 14. Lid 10 is in an unlocked position when internal locking protrusions 12 of lid 10 are aligned with cutouts 44 of body 14. In this position, lid 10 is pulled up to detach from body 14. Lid 10 can also snap on and attach to body 14 when internal locking protrusions 12 are aligned with cutouts 44. Lid 10 is adjusted to a locked position when twisted to enable internal locking protrusions 12 to slide within slots 16 of body 14 and away from cutouts 44.

In operation, the skateboard tool is configured to store a plurality of tools within inner cavity 46 as needed. In one embodiment, the plurality of tools comprise ⅜″ socket 20, ½″ socket 22, 9/16″ socket 24, L-tool 26, griptape file 28, razor blade 30, axle rethreader 32, bit driver 34 and bearing press 38. Lid 10 is removed from body 14 to permit the plurality of tools to be disposed within internal cavity 46. Lid 10 is attached to body 14 to enclose internal cavity 46 and store the plurality of tools as depicted in FIG. 7. Lid 10 is detached from body 14 to permit the removal of any number of tools for use.

It shall be appreciated that the plurality of tools may be stacked and arranged in a variety of configurations within internal cavity 46 of skateboard tool as desired. In one exemplary configuration, ⅜″ socket 20, ½″ socket 22 and 9/16″ socket 24 are stacked in the middle of internal cavity 46. Griptape file 28 may be disposed through the middle of sockets 20, 22, 24 or set aside within internal cavity 46. Bit driver 34 may be disposed through the middle of sockets 20, 22, 24 or set aside within internal cavity 46. L-tool 26, razor blade 30, axle rethreader 32 and bearing press 38 may be positioned in the remaining space available within internal cavity 46 of body 14.

The plurality of tools can be used to replace and/or readjust components of the skateboard. The following description is directed to exemplary but non-limiting uses of the tools. Bit driver 34 is coupled to driver 36 to permit the attachment of any socket thereon. The user grips body 14 of the skateboard tool to use the sockets. The ⅜″ socket 20 may be used to ratchet nuts used to secure the skateboard's trucks to the deck. The ½″ socket 22 may be used to ratchet nuts to secure wheels to the skateboard's trucks. The 9/16″ socket 24 may be used to adjust the skateboard's kingpin nuts, which alter the skateboard's turning dynamics according to the rider's preference.

L-tool 26 preferably comprises a first end with an Allen wrench and a second end with a Phillips screwdriver head. L-tool 26 may be used to adjust screws that engage with nuts used to secure the skateboard's trucks to the deck. In certain circumstances, griptape is applied to the deck of a skateboard to enhance traction with the rider. Griptape file 28 may be used by hand to manually flatten the griptape so that it adheres to the skateboard's deck more effectively. Razor blade 30 may be used to cut the griptape to the desired dimensions to better accommodate the skateboard. Axle rethreader 32 is used by hand to manually repair the skateboard's axles at locations where the threads become worn. Bearing press 38 may be used to help a user to secure a bearing to each of the skateboard's wheels.

It shall be appreciated that the components of the skateboard tool described in several embodiments herein may comprise any alternative known materials in the field and be of any color, size and/or dimensions. It shall be appreciated that the components of the skateboard tool described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

What is claimed is:

1. A skateboard tool with enhanced portability and storage capacity to store a plurality of tools, the plurality of tools configured for use by a user to service a skateboard, the skateboard tool comprising:
a main body member comprising an upper portion, a lower portion opposite the upper portion, and a side wall connecting the upper and lower portions together, the upper portion comprising an upper opening that extends to an internal cavity formed by the side wall and the lower portion, the internal cavity configured to store the plurality of tools therein;
a lid detachably coupled to the upper portion of the main body member to enclose the internal cavity; and
a driver coupled to the lower portion of the main body member;
wherein the plurality of tools is disposed within the internal cavity of the main body member and comprises at least one socket configured to couple to the driver, the socket configured to communicate with the skateboard to permit the user to perform a maintenance on the skateboard.

2. The skateboard tool of claim 1 further comprising a lower neck connecting the driver to the lower portion of the main body member, the lower neck comprising a first diameter that is less than a second diameter of the main body member.

3. The skateboard tool of claim 2, further comprising a ratchet mechanism disposed within the lower neck and operably connected to the driver.

4. The skateboard tool of claim 3, further comprising a pair of grip protrusions coupled to an exterior surface of the main body member that conform to contours of a hand of the user.

5. The skateboard tool of claim 4, further comprising a pair of slots disposed in the upper portion of the main body member proximate the upper opening and a pair of corresponding locking protrusions coupled to the lid, wherein the pair of locking protrusions in the lid is configured to communicate with the pair of slots in the main body member to permit the lid to slidably adjust relative to the main body member into a locked position or unlocked position.

6. The skateboard tool of claim 5, wherein the plurality of tools are selected from the group consisting of a first socket, a second socket, a third socket, an axle rethreader, a bit driver, a griptape file, a bearing press, a razor blade, and a L-tool comprising an Allen wrench on a first side and a Philips screw driver head on a second side.

7. The skateboard tool of claim 5, wherein the plurality of tools comprise a first socket, a second socket, a third socket, an axle rethreader, a bit driver, a griptape file, a bearing press, a razor blade, and a L-tool comprising an Allen wrench on a first side and a Philips screw driver head on a second side.

8. The skateboard tool of claim 7, wherein each socket in the first, second and third sockets comprises a different size compared to other sockets in the first, second and third sockets.

9. The skateboard tool of claim 8, wherein the first socket is an approximately ⅜″ socket, the second socket is an approximately ½″ socket and the third socket is an approximately 9/16″ socket.

10. The skateboard tool of claim 9, wherein the bit driver is coupled to the driver to permit any socket of the ⅜″ socket, ½″ socket and 9/16″ socket to be secured thereto.
